(19) United States
(12) Patent Application Publication
(10) Pub. No.: US 2022/0182008 A1
(43) Pub. Date: Jun. 9, 2022

(54) SINGLE AXIS SOLAR TRACKER ROTATION STOPPER

(71) Applicant: Gamechange Solar Corp., Norwalk, CT (US)

(72) Inventor: Andrew Barron Worden, Redding, CT (US)

(73) Assignee: Gamechange Solar Corp., Norwalk, CT (US)

(21) Appl. No.: 17/394,138

(22) Filed: Aug. 4, 2021

Related U.S. Application Data
(60) Provisional application No. 63/064,068, filed on Aug. 11, 2020.

(51) Int. Cl. H02S 20/32; F16M 11/10; F16M 11/18

(52) U.S. Cl. CPC H02S 20/32; F16M 11/18; F16M 11/10

(57) ABSTRACT

A variable length shaft is installed between one of the posts in the single axis tracker and a yardarm extending from the row tube, perpendicular to it. Stops in the variable length shaft correspond to the shaft length when the single axis tracker is at its maximum rotation angle to the east and to the west. The shaft provides a structural support that bears some of the self-weight torque. In this way the tracker table will not exceed the design maximum tilt to the east or west and the tracking accuracy of the system will meet the desired level.

### CROSS REFERENCE TO RELATED APPLICATIONS

This application claims the benefit of U.S. Provisional Patent Application Ser. No. 63/064,068 filed Aug. 11, 2020, which is hereby incorporated by reference.

### BACKGROUND OF THE INVENTION

### 1. Technical Field

This disclosure relates generally to a solar panel installation and, more particularly, to apparatuses and assemblies that include stops to prevent over rotation of the solar panels in a solar panel installation.

### 2. Background Information

Single axis trackers are now relatively common in the solar industry. The solar trackers must be designed to support the applicable loads: self-weight (dead load), snow, wind, seismic, etc. per local building codes. However, the vast majority of the time, the only significant loading is from self-weight. As the center of gravity is offset horizontally from the center of rotation of the tracker table for any tilt angle of the panels other than flat, a torque due to self-weight is applied to the tracker row tube for the majority of tilt angles of the tracker. Depending on the weight of the supported solar modules and the distance between the center of gravity of the modules and the center of rotation of the tube, this self-weight torque can be significant enough to cause a meaningful rotational deflection of the row tube. As the purpose of a single axis solar tracker is to rotate the solar modules so they are always perpendicular to the beam of light from the sun (often referred to as tracking accuracy), this rotation due to self-weight can have a meaningful impact on that perpendicularity and therefore the energy production and revenue from the solar tracker.

### SUMMARY OF THE DISCLOSURE

According to an aspect of the present disclosure, a single axis tracker systems are currently a common way of supporting solar photovoltaic modules such that the modules rotate about the North-South axis to follow the sun in its arc from East to West each day. The single axis solar tracker includes a row tube or other structural beam that is oriented North-South. The row tube is supported periodically along its length by bearings which in turn are supported by posts that are embedded or otherwise affixed to the ground. At one or multiple points along the row tube a drive system exists to rotate the row tube. An example of a drive system is a linkage system with a linear actuator and a rotating arm such that as the actuator expands and contracts the row tube is rotated clockwise and counterclockwise respectively when the row tube is viewed looking north. The solar modules are mechanically affixed to the row tube and therefore are rotated to the East or West throughout the day by the motion of the row tube and drive system. A variable length shaft is installed between one of the posts in the single axis tracker and a yardarm extending from the row tube, perpendicular to it. Both the yardarm and the varying length shaft are in a plane perpendicular to the longitudinal axis of the row tube. Rotation stops are located in the variable length shaft and correspond to the shaft length when the single axis tracker is at its maximum rotation angle to the east and to the west. In other words, the shaft will become a structural support that bears some of the self-weight torque. In this way, the rotation stops ensure the tracker table will not exceed the design maximum tilt to the east or west and the tracking accuracy of the system will meet the desired level.

The variable length shaft may be configured as two tubes that telescope one into the other.

A spring may be installed at the joint(s) between the telescopic parts of the variable length shaft to prevent impact loading when the mechanical stop length is reached.

In one exemplary embodiment, the variable length shaft includes a damper. In this way the damping and other harmonic properties of the tracker table will be improved. This will result in higher critical wind speeds for aeroelastic stability, allowing the tracker to follow the sun in higher wind speeds and thus increase energy production and revenue from the single axis tracker system.

Stoppers (e.g., rubber) may be installed as part of the mechanical stops. The stoppers alone or in combination with springs or dampers prevent a “hard stop” from occurring when the variable length shaft reaches one extreme of travel and therefore prevents an impact type load from being applied to the solar photovoltaic modules on the single axis tracker.

Eyelets may be installed on either end of the variable length shaft. These provide for a quick and cost-effective mechanism of attaching the rotation stopper to the single axis tracker structure via a bolted connection.

The foregoing features and the operation of the invention will become more apparent in light of the following description and the accompanying drawings.

### BRIEF DESCRIPTION OF THE DRAWINGS

FIG. 1 illustrates a solar panel installation;

FIG. 2 illustrates an exemplary embodiment of a rotatable shaft;

FIG. 3 illustrates a bearing assembly configured to rotatably mount the rotatable shaft;

FIG. 4 illustrates an exemplary embodiment of a drive mechanism to rotate the rotatable shaft;

FIG. 5 illustrates an embodiment of a rotation stopping assembly;

FIG. 6 illustrates an alternative embodiment rotation stopping assembly that includes a first damper and a second damper;

FIG. 7 is first perspective view of another alternative embodiment rotation stopping assembly that includes solar tracker rotation stoppers;

FIG. 8 is a second perspective view of the another alternative embodiment rotation stopping assembly of FIG. 7 that includes the solar tracker rotation stoppers;

FIG. 9 illustrates a variable length shaft that may include a plurality of tubes that telescope one into the other and include rotation stoppers that correspond to the maximum range of motion for the tracker; and

FIG. 10 illustrates an alternative embodiment variable length shaft that may include a plurality of tubes that telescope one into the other and include rotation stoppers that correspond to the maximum range of motion for the tracker with a spring.

### DETAILED DESCRIPTION

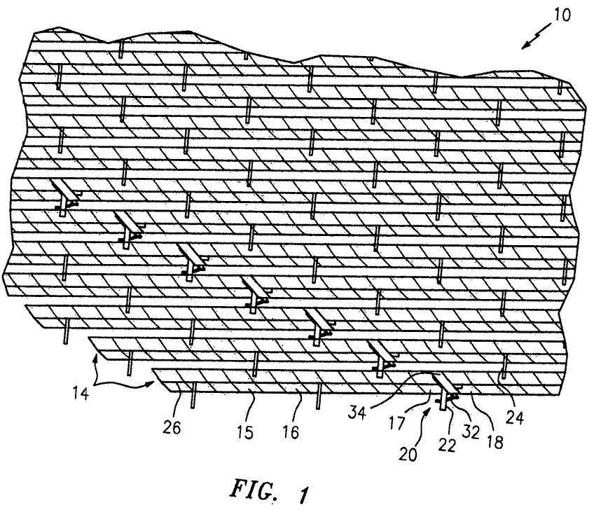

FIG. 1 illustrates a solar panel installation 10. An exemplary embodiment of such a solar panel installation is the Genius Tracker™ system designed by Game Change Solar of Norwalk, Conn. Of course, the solar panel installation of the present disclosure is not limited to the specific exemplary. For examples, one or more of the Genius Tracker™ system components may be swapped out for components with alternate configurations, one or more of the Genius Tracker™ system components may be omitted and/or the Genius Tracker™ system may be modified to include one or more additional components not specifically described herein.

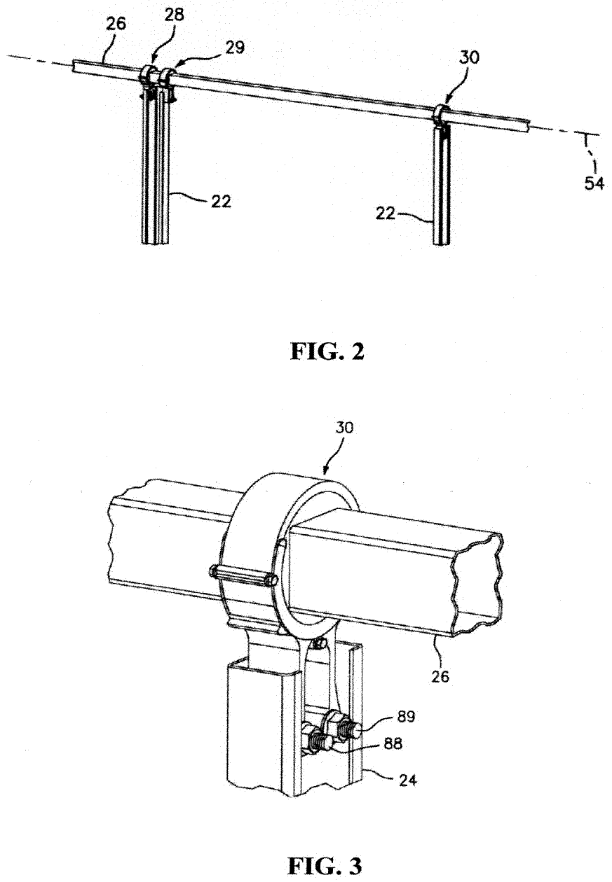

Referring again to FIG. 1, the solar panel installation 10 includes one or more solar panel arrays 12, 14. Each of these solar panel arrays 12, 14 includes one or more solar panels 15-18 (e.g., a linear array of solar panels) mounted to a racking structure 20. Each racking structure 20 includes a plurality of stationary structural members 22, 24, a rotatable shaft/row tube 26, a plurality of bearing assemblies 28, 30 (see FIG. 2), and at least one drive mechanism 32. Each racking structure 20 may also include at least one wind break panel 34 for configuring with the drive mechanism 32.

FIG. 2 illustrates an exemplary embodiment of the rotatable shaft/row tube 26. The rotatable shaft has a length, which extends axially (e.g., substantially horizontally when installed) along a rotational axis 54. The rotatable shaft may be configured as a single length of shaft as shown in FIG. 2. Alternatively, the rotatable shaft 26 may be configured with a plurality of shaft segments. The exemplary rotatable shaft 26 may have a polygonal (e.g., square) cross-sectional geometry; however, the rotatable shaft of the present disclosure is not limited to such a geometry.

Referring to FIGS. 2-3, the bearing assemblies 28-30 are configured to rotatably mount the rotatable shaft 26 to the stationary structural members 22, 24.

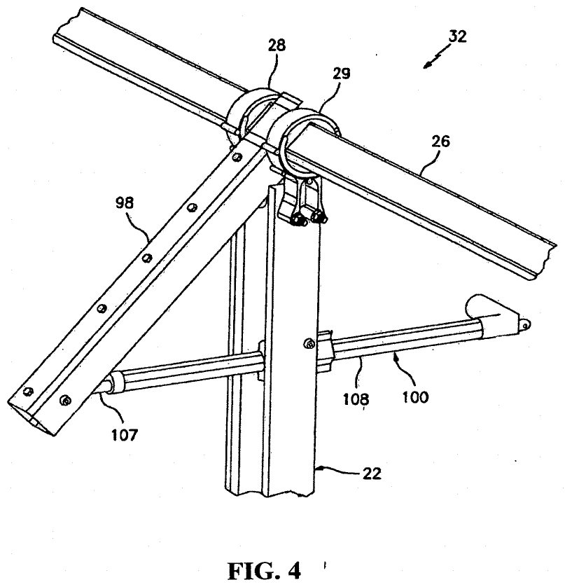

FIG. 4 illustrates an exemplary embodiment of the drive mechanism 32. This drive mechanism includes a drive arm 98 and an actuator 100. The drive arm 98 is substantially axially aligned with the stationary structural member 22 along the rotational axis. A first end of the drive arm is secured to the rotatable shaft 26. Distal end flanges of the drive arm 98, for example, are clamped around the rotatable shaft 26 between two adjacent and proximate bearing assemblies 28, 29.

The actuator 100 may be a hydraulic piston actuator or a screw drive mechanism actuator. The actuator may thereby include a pushrod 107 and a base 108, where the push rod 107 projects out from and slides within and relative to the base. The pushrod 107 may be pivotally connected to the drive arm 98. The base 108 may be pivotally connected to the stationary structural member 22. Of course, the drive mechanism of the present disclosure is not limited to the foregoing exemplary actuator configuration or mounting scheme.

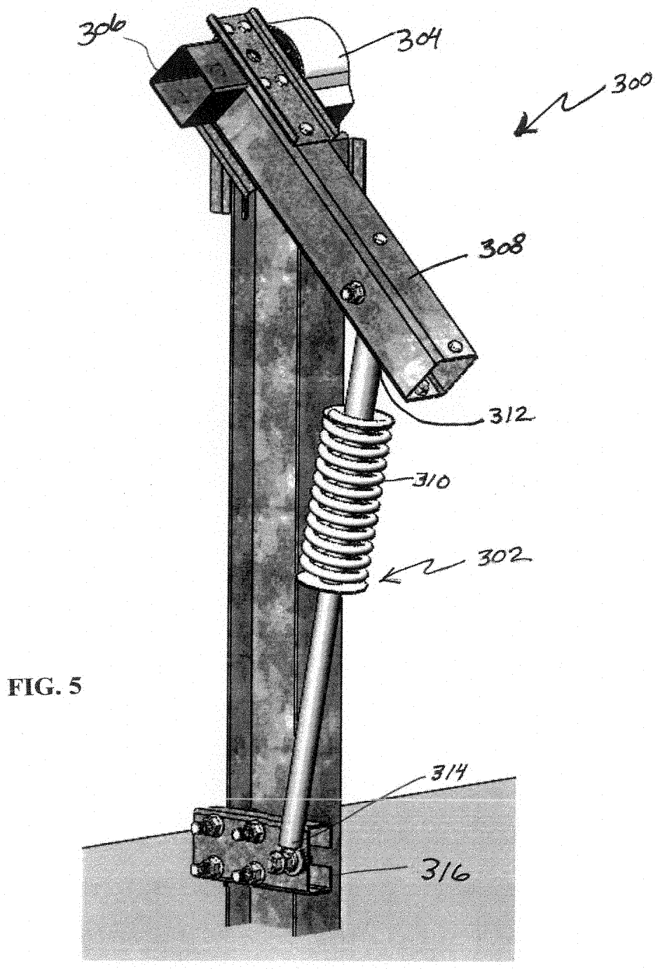

FIG. 5 illustrates a rotation stopping assembly 300 that includes a damper 302. As shown in FIG. 5, a bearing assembly 304 secures rotatable shaft/row tube 306, which is connected to an arm 308. The damper 302 may include a shock absorber having a piston and piston rod and a coaxial cooperating spring 310. A first end 312 of the damper is connected to the arm 308 while a second end 314 of the damper is connected to a post 316. The shock absorber and spring of the rotation stopping assembly 300 prevent the tracker from over rotation and from moving back and forward too much, which allows trackers to be longer and handle higher wind speeds.

The rotation stopping assembly 300 may be mounted to a stationary structural member/post separate from the stationary structural member/post the drive mechanism 32 is mounted to (see FIG. 4). In general, the rotation stopping assembly 300 may be located closer to a distal or proximate end of the solar panel arrays 12, 14 than the drive mechanism. For example, in one embodiment, if the solar panel array is length L, then a rotation stopping assembly may be mounted to a stationary structural member/post that is located about 5-30% of the length L in from a distal or proximate end of the solar panel array. In one embodiment, the rotation stopping assembly may be mounted to a stationary structural member/post located about 10-15% of the length L in from a distal or proximate end of the solar panel array.

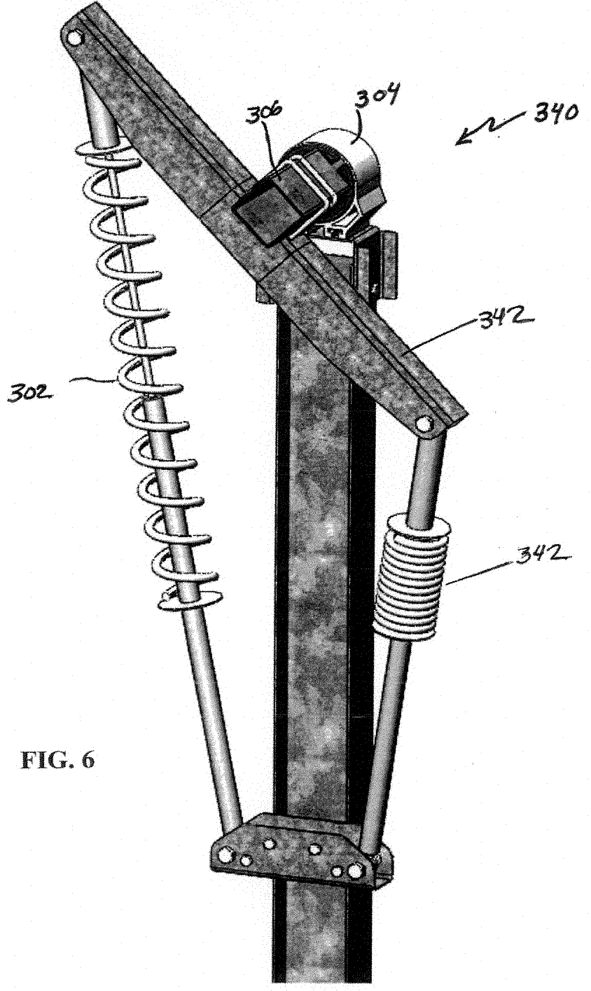

FIG. 6 illustrates a portion of an alternative embodiment rotation stopping assembly 340 that includes a first damper 302 and a second damper 342. The bearing assembly 304 secures the rotatable shaft 306, which is connected to an arm 344. The first damper 302 is connected to a first end of the arm 344, and the second damper 342 is connected to a second end of the arm 344. This embodiment also prevents over rotation and increases the stability of the tracker in high winds.

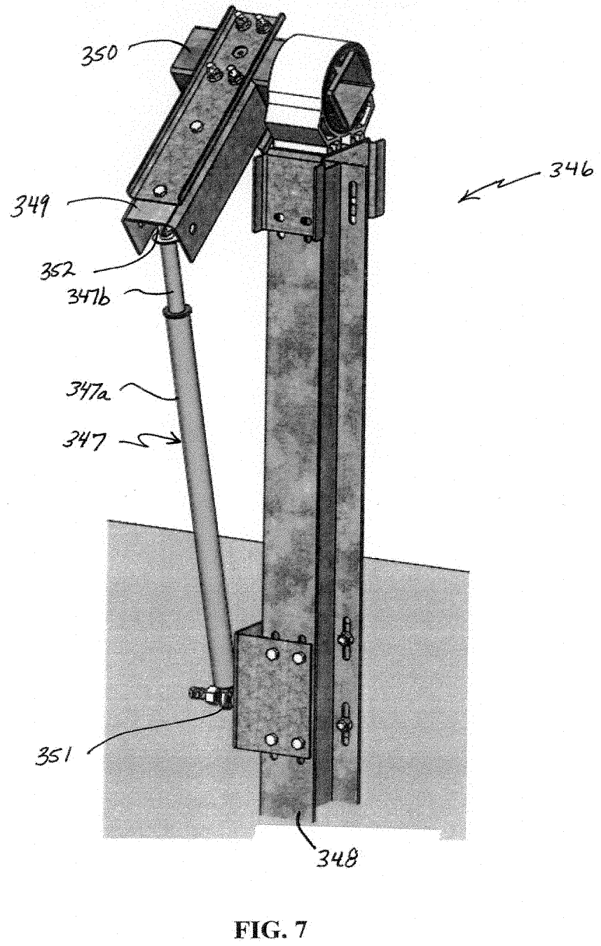

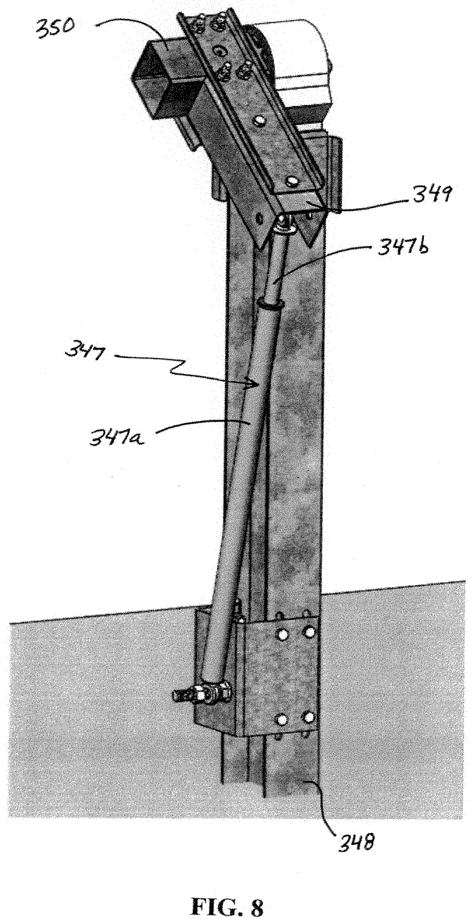

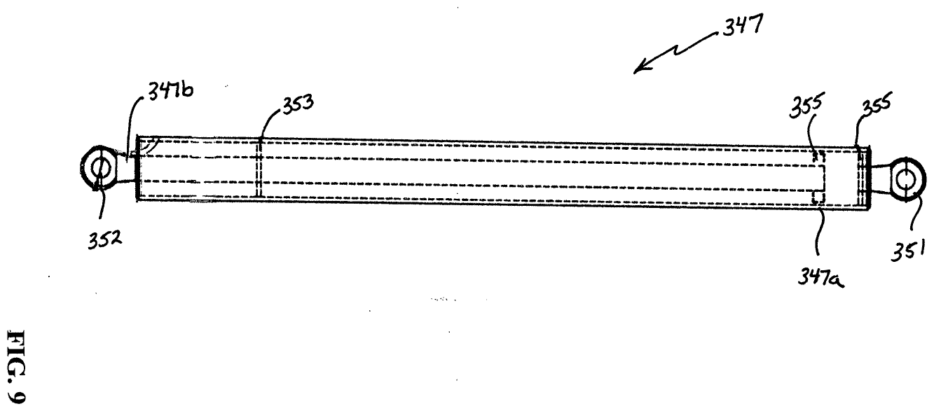

FIG. 7 is first perspective view of another alternative embodiment rotation stopping assembly 346 that includes solar tracker rotation stoppers. FIG. 8 is a second perspective view of the another alternative embodiment rotation stopping assembly of FIG. 7. Referring to FIGS. 7 and 8, the rotation stopping assembly 346 may be used with a single axis solar tracker and includes a shaft 347 of varying length with mechanical stops. The variable length shaft 347 may include a plurality of tubes (e.g., two tubes 347a, 347b) that telescope one into the other.

The variable length shaft 347 is installed between a post 348 of the single axis tracker and an arm 349 extending from rotatable shaft/row tube 350, perpendicular to it. Both the yardarm 349 and the varying length shaft 347 are in a plane perpendicular to the longitudinal axis of the row tube.

FIG. 9 illustrates an embodiment of the variable length shaft 347 that may include the plurality of tubes 347a, 347b that telescope one into the other and include stoppers/bumpers that correspond to the maximum range of motion for the tracker. In this exemplary embodiment a first bumper (e.g., an elastomeric material) 353 with a central through hole coaxial with the tubes 347a, 347b may be affixed to the inner diameter of the outer tube 347a. The inner tube 347b may include a coaxial projection 354 that limits the amount of travel of the inner tube 347b from the outer tube 347a when the projection 354 abuts the first bumper 353. The first bumper 353 is preferably an elastomeric (e.g., rubber) to provide vibration and shock isolation when the projection 354 reaches the first bumper 353. Similarly, a second bumper 355 may be located a second location within and affixed to the outer tube 347a to act as a stop to prevent the inner tube 347b from retracting too far, and damping the vibration and shock when the variable length shaft 347 is fully retracted. The second bumper 355 may also be elastomeric.

The stoppers/bumpers 353, 355 may be positioned based upon the maximum range of travel. That is, the stoppers 353, 355 in the variable length shaft 347 correspond to the shaft length when the single axis tracker is at its maximum rotation angle to the east and to the west. In other words, the shaft 347 will become a structural support that bears some of the self-weight torque. In this way the tracker table will not exceed the design maximum tilt to the east or west and the tracking accuracy of the system will meet the desired level. The rubber stoppers alone or in combination with springs or dampers prevent a “hard stop” from occurring when the variable length shaft reaches one extreme of travel and therefore prevents an impact type load from being applied to the solar photovoltaic modules on the single axis tracker.

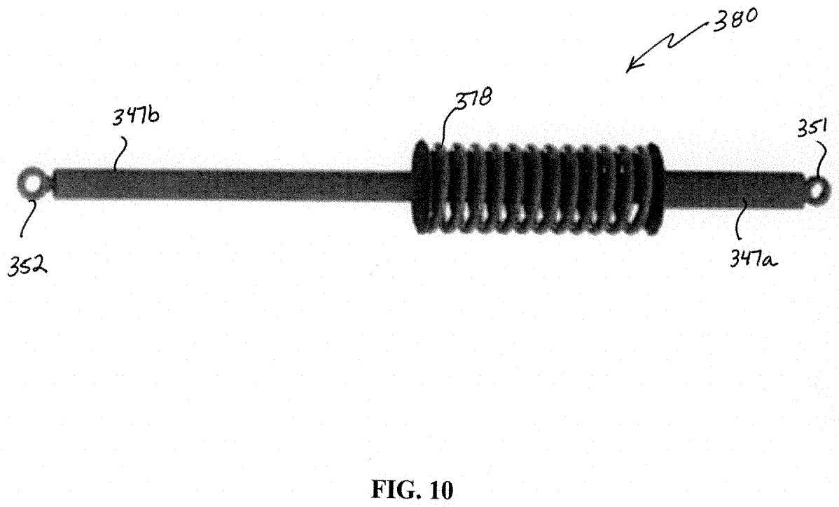

Referring to FIG. 10, it is contemplated that alternative embodiment damping assembly 380 may include spring 378 installed at the joint(s) between the telescopic tubes 347a, 347b parts of the variable length shaft 347, and co-axial with the tubes, to prevent impact loading when the mechanical stop length is reached.

A damper may be part of the variable length shaft 347. In this way the damping and other harmonic properties of the tracker table will be improved. This will result in higher critical wind speeds for aeroelastic stability, allowing the tracker to follow the sun in higher wind speeds and thus increase energy production and revenue from the tracker system.

Referring to FIGS. 7-10, eyelets 351, 352 are installed on either end of the variable length shaft 347. These provide for a quick and cost-effective mechanism for attaching the variable length shaft 347 to the single axis tracker structure via a bolted connection.

Each of the solar panel arrays 12, 14 (FIG. 1) may include one or more rotation stopping assembly. For example, two rotation stopping assemblies may be mounted on each side of the drive mechanism.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An assembly for a solar panel installation, the assembly comprising:
a stationary structural member having a length that extends longitudinally to a distal member end;
a rotatable shaft having a rotatable axis, wherein the rotatable shaft is rotatably connected to the stationary structural member at the distal member end by one or more bearings;
an arm secured to the rotatable shaft; and
a rotation stopping assembly having a first lengthwise end and a second lengthwise end, the first lengthwise end is rotatably connected to the arm and the second lengthwise end is rotatably connected to the stationary structural member, where the rotation stopping assembly comprises a variable length shaft that includes an outer tube and a coaxial inner tube, where the outer tube includes a first stopper affixed to an inner surface of the outer tube and includes a through hole coaxial with the inner tube, and a radial projection extending from and affixed to the inner tube such that the first stopper and the radial projection limit axial travel of the inner tube within the outer tube.

2. The assembly of claim 1, further comprising a second stopper affixed to a radially interior side of the outer tube to prevent the inner tube from retracting beyond the second stopper.

3. The assembly of claim 2, where the rotation stopping assembly comprises a damper that includes the first and second tubes and radial projection.

4. The assembly of claim 2, where the rotation stopping assembly comprises a dashpot that includes the first and second tubes and radial projection.

5. The assembly of claim 2, where the rotation stopping assembly comprises a shock absorber.

6. The assembly of claim 4, where the shock absorber comprises a dashpot and a coaxial spring, where when fully compressed the coaxial spring acts as a dashpot and limits movement of the inner tune relative to the outer tube.

7. The assembly of claim 1, where the rotatable shaft is perpendicular to the stationary structural member.

8. The assembly of claim 7, where the stationary structural member is configured to be securely anchored to the ground.

9. A solar panel array, comprising:
a plurality of stationary structural members each extending from a surface and arranged along a longitudinal axis;
a plurality of solar panels rotatably mounted to the plurality of stationary structural members;
a drive mechanism mounted to a first of the plurality of stationary structural members to rotate the plurality of solar panels about an axis of rotation that is parallel to the longitudinal axis;
a rotatable shaft that rotates about axis of rotation, wherein the rotatable shaft is rotatably connected to the first and the second of the plurality of stationary structural members;
an arm secured to the rotatable shaft; and
a rotation stopping assembly mounted to a second of the plurality of stationary structural members, the rotation stopping assembly comprising first lengthwise end and a second lengthwise end, the first lengthwise end is rotatably connected to the arm and the second lengthwise end is rotatably connected to the stationary structural member, where the rotation stopping assembly comprises a variable length shaft that includes an outer tube and a coaxial inner tube, where the outer tube includes a first stopper affixed to an inner surface of the outer tube and includes a through hole coaxial with the inner tube, and a radial projection extending from and affixed to the inner tube such that the first stopper and the radial projection limit axial travel of the inner tube within the outer tube.

10. The solar panel array of claim 9, further comprising a second stopper affixed to a radially interior side of the outer tube to prevent the inner tube from retracting beyond the second stopper.

11. The solar panel array of claim 10, where the first and second stoppers are elastomeric.

12. The solar panel array of claim 11, where the first stopper extends perpendicularly from the inner surface of the outer tube.

13. The solar panel array of claim 12, where the radial projection extends perpendicularly from the inner tube.

14. The solar panel array of claim 13, where the inner and outer tubes form one of a pneumatic or hydraulic chamber.

15. The solar panel array of claim 14, where the radial projection is sized to operate as a dashpot within the outer housing.
